(19) United States
(12) Patent Application Publication
(10) Pub. No.: US 2018/0010481 A1
(43) Pub. Date: Jan. 11, 2018

(54) ENGINE PERFORMANCE MODELING BASED ON WASH EVENTS

(71) Applicant: GE Aviation Systems LLC, Grand Rapids, MI (US)

(72) Inventors: David Geoffrey Dauenhauer, Cincinnati, OH (US); Ronald Matthew DiMuro, Loveland, OH (US); Brian William Pfeiffer, Liberty Township, OH (US); Rob Anthony, Mason, OH (US); Adam Joseph Schroeder, Cincinnati, OH (US); Will Munnerlyn, Cincinnati, OH (US)

(21) Appl. No.: 15/642,801

(22) Filed: Jul. 6, 2017

Related U.S. Application Data
(60) Provisional application No. 62/359,985, filed on Jul. 8, 2016.

(51) Int. Cl. F01D 25/00; B64D 31/00; F01D 21/00

(52) U.S. Cl. CPC F01D 25/002; F01D 21/003; B64D 31/00; F05D 2220/323

(57) ABSTRACT

One example aspect of the present disclosure is directed to a method for measuring engine performance. The method includes receiving a plurality of parameters related to engine performance. The method includes receiving an indication of an engine wash event. The method includes determining an effectiveness of the engine wash event based on the plurality of parameters. The method includes performing a comparison of the effectiveness of the engine wash event with an expected effectiveness of the engine wash event. The method includes performing a control action based on the comparison.

### PRIORITY CLAIM

The present application claims the benefit of priority of U.S. Provisional Patent Application No. 62/359,985, entitled “ ENGINE PERFORMANCE MODELING BASED ON WASH EVENTS,” filed Jul. 8, 2016, which is incorporated herein by reference for all purposes.

### FIELD

The present subject matter relates generally to aerial vehicles.

### BACKGROUND

An aerial vehicle can rely on one or more engines to control the aerial vehicle. Engine performance can be affected by cleanliness of the engine. Washing the engine regularly can improve the performance of the engine and extend the life of the engine. However, washing the engine unnecessarily can waste resources. It can be difficult to determine an optimal number of flights for the engine before the engine should receive a wash.

### BRIEF DESCRIPTION

Aspects and advantages of embodiments of the present disclosure will be set forth in part in the following description, or may be learned from the description, or may be learned through practice of the embodiments.

One example aspect of the present disclosure is directed to a method for measuring engine performance. The method includes receiving a plurality of parameters related to engine performance. The method includes receiving an indication of an engine wash event. The method includes determining an effectiveness of the engine wash event based on the plurality of parameters. The method includes performing a comparison of the effectiveness of the engine wash event with an expected effectiveness of the engine wash event. The method includes performing a control action based on the comparison.

Another example aspect of the present disclosure is directed to a system. The system includes one or more memory devices. The system includes one or more processors. The one or more processors are configured to receive a plurality of parameters related to engine performance. The one or more processors are configured to receive an indication of an engine wash event. The one or more processors are configured to determine an effectiveness of the engine wash event based on the plurality of parameters. The one or more processors are configured to perform a comparison of the effectiveness of the engine wash event with an expected effectiveness of the engine wash event. The one or more processors are configured to perform a control action based on the comparison.

Other example aspects of the present disclosure are directed to systems, methods, aerial vehicles, avionics systems, devices, non-transitory computer-readable media for measuring engine performance. Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an aerial vehicle according to example embodiments of the present disclosure;

FIG. 2 depicts a flow diagram of an example method according to example embodiments of the present disclosure;

FIG. 3 depicts a flow diagram of an example method according to example embodiments of the present disclosure;

FIG. 4 depicts a flow diagram of an example method according to example embodiments of the present disclosure;

FIG. 5 depicts a computing system for implementing one or more aspects according to example embodiments of the present disclosure; and

FIG. 6 depicts an example interface according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the embodiments. In fact, it will be apparent to those skilled in the art that various modifications and variations can be made in the present disclosure without departing from the scope or spirit of the invention. For instance, features illustrated or described as part of one embodiment can be used with another embodiment to yield a still further embodiment. Thus, it is intended that the present disclosure covers such modifications and variations as come within the scope of the appended claims and their equivalents.

As used in the specification and the appended claims, the singular forms “a,” “an,” and “the” include plural referents unless the context clearly dictates otherwise. The use of the term “about” in conjunction with a numerical value refers to within 25% of the stated amount.

Example aspects of the present disclosure are directed to methods and systems that can measure engine performance. The aerial vehicle can transmit (e.g., deliver, send, etc.) parameters to a ground system. The parameters can include and/or can be used to determine Exhaust Gas Temperature (EGT), EGT Hot Day Margin (EGTHDM), fuel burn, modular efficiency, other analytic measures of engine performance, the like, and/or any combination of the foregoing. The parameters can be collected as a part of normal operation of the aerial vehicle even in the absence of the systems and methods according to the present disclosure.

When an engine is washed, one or more attributes related to the wash can be determined (e.g., recorded, measured, calculated, etc.). The one or more engine wash attributes can include one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, an equipment type, and/or other relevant attributes to a defined wash procedure.

Parameters related to a threshold number of flights before the engine wash can be analyzed (e.g., examined, studied, etc.). In an embodiment, the parameters before the wash can be plotted to on a graph to determine deterioration in engine performance. In an embodiment, a first regression line for projecting deterioration in engine performance can be created based on the graph. Parameters related to a threshold number of flights after the engine wash can be analyzed. In an embodiment, the parameters after the wash can be plotted on a graph to determine deterioration in engine performance. In an embodiment, a second regression line for projecting deterioration in engine performance can be created based on the graph.

The effectiveness of the engine wash can be determined by analyzing the parameter before the engine wash and the parameters after the engine wash. In an embodiment, the first regression line can be compared with the second regression line. The difference in the first regression line and the second regression line can be considered a reduction in the deterioration in engine performance attributable to the engine wash.

The effectiveness of the engine wash can be compared against an expected effectiveness of the engine wash. The expected effectiveness of the engine wash can be based on manufacturer information, wash station information, aggregated engine wash information, one or more models of engine wash effectiveness for an engine, one or more models of engine wash effectiveness for a plane, one or more models of engine wash effectiveness for a fleet, the like, and/or any combination of the foregoing. The expected effectiveness of the engine wash can be based on one or more attributes of the engine wash. An action can be performed based on the comparison. For example, a subsequent engine wash, a service, and/or a maintenance action can be scheduled based on the comparison.

In this way, the systems and methods according to example aspects of the present disclosure have a technical effect of measuring how engine washes affect engine performance.

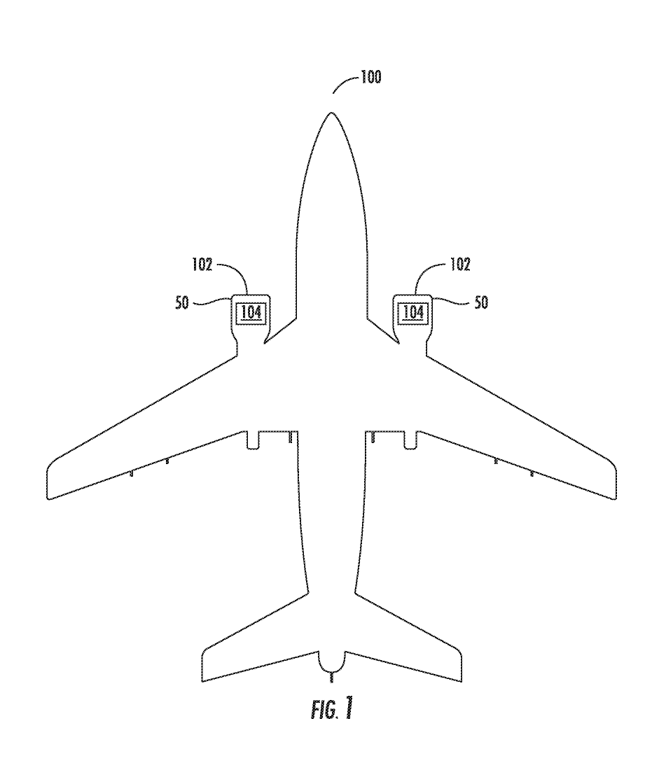

FIG. 1 depicts a block diagram of an aerial vehicle 100 according to example embodiments of the present disclosure. The aerial vehicle 100 can include one or more engines 102. The one or more engines 102 can cause operations, such as propulsion, of the aerial vehicle 100. An engine 102 can include a nacelle 50 for housing components. An engine 102 can be a gas turbine engine. A gas turbine engine can include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

The one or more engines 102 can include and/or be in communication with one or more electronic engine controllers (EECs) 104. The one or more EECs 104 can record data related to the one or more engines 102.

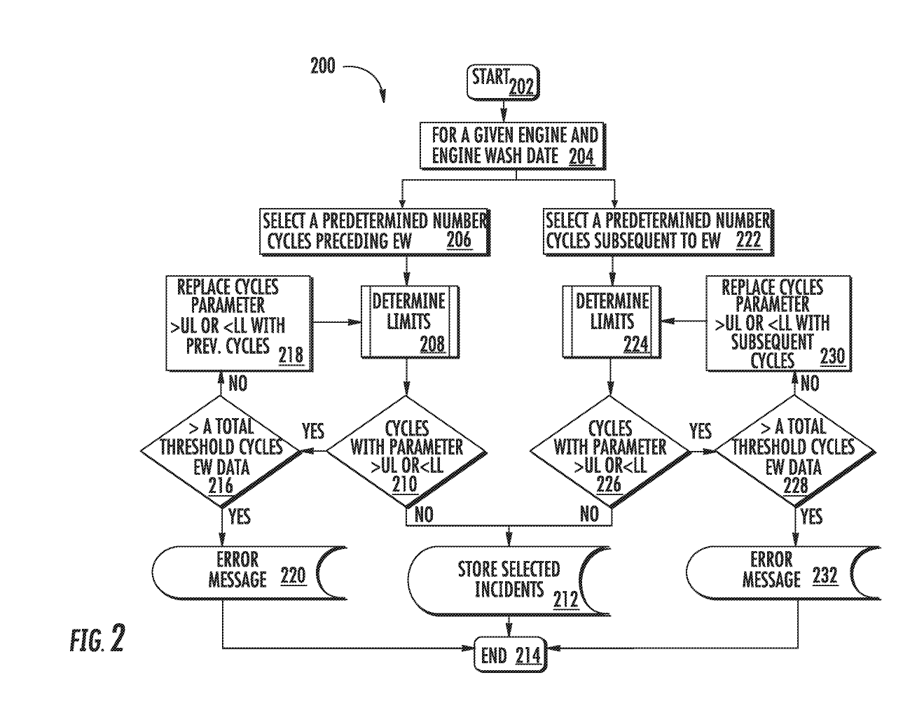

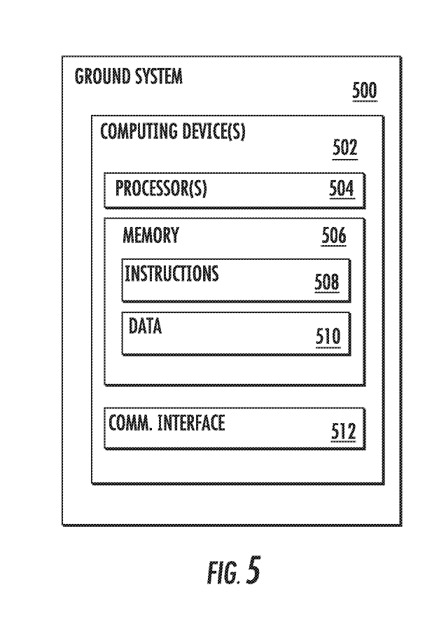

FIG. 2 depicts a flow diagram of an example method 200 for calculating engine wash effectiveness. The method of FIG. 2 can be implemented using, for instance, the one or more computing devices 502 of the ground system 500 of FIG. 5. FIG. 2 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (202), the method 200 can start. For instance, the one or more computing devices 502 of the ground system 500 can start the method 200. At (204), an engine wash event associated with an engine for which the effectiveness will be determined can be selected (e.g., determined, etc.). For instance, the one or more computing devices 502 of the ground system 500 can select an engine wash event associated with an engine for which the effectiveness will be determined.

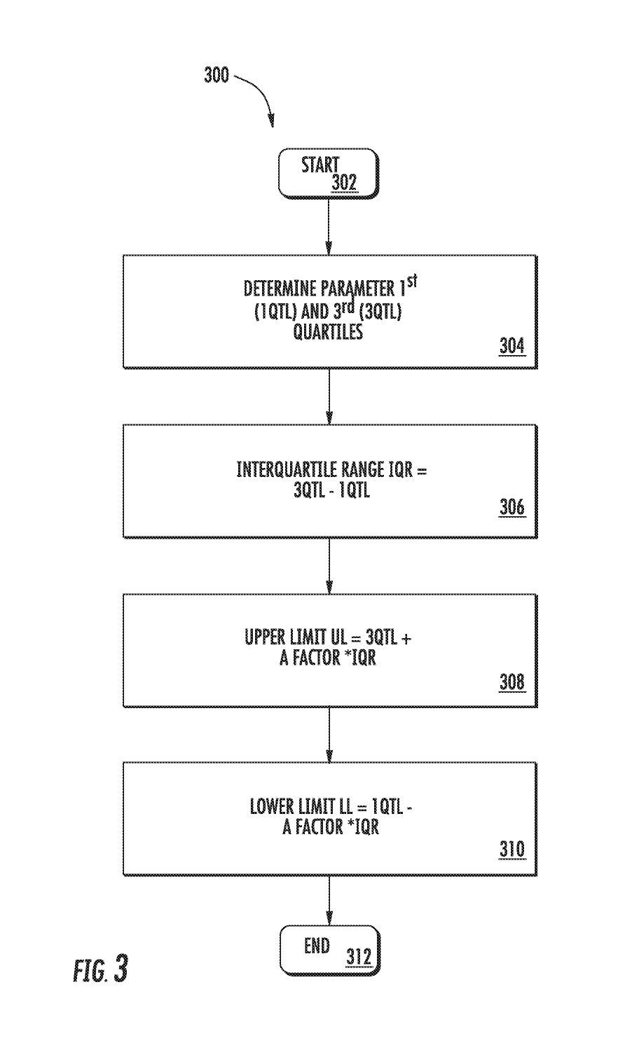

At (206), a predetermined number of incidents preceding the engine wash event can be selected. For instance, the one or more computing devices 502 of the ground system 500 can select a predetermined number of incidents preceding the engine wash event. In an embodiment, the incidents can be flights, engine power cycles, points of data captured at any frequency, and/or the like. In an embodiment, the predetermined number of incidents preceding the engine wash event can be 20. In other embodiments, the predetermined number of incidents preceding the engine wash event can be any other number. At (208), limits can be determined. For instance, the one or more computing devices 502 of the ground system 500 can determine limits. The determined limits include an upper limit and a lower limit. The determined limits can be determined for one or more parameters related to engine performance. The one or more parameters related to engine performance can include Exhaust Gas Temperature (EGT), EGT Hot Day Margin (EGTHDM), fuel burn, modular efficiency, other analytic measures of engine performance, the like, and/or any combination of the foregoing. A method for determining limits will be described in more detail in FIG. 3 below.

At (210), a determination can be made of if the selected incidents include any incidents with a parameter above the upper limit or a parameter below the lower limit. For instance, the one or more computing devices 502 of the ground system 500 can determine if the selected incidents include any incidents with a parameter above the upper limit or a parameter below the lower limit. If not, then the method 200 can move to (212) and data for all of the selected incidents can be stored (e.g., load, record, etc.) to be used in analysis. For instance, the one or more computing devices 502 of the ground system 500 can store data for all of the selected incidents. After (212), the method 200 can move to (214) and end. For instance, the one or more computing devices 502 of the ground system 500 can end the method 200.

If the selected incidents include any incidents with a parameter above the upper limit or a parameter below the lower limit, the method can move to (216) and a total number of incidents considered can be compared against a total threshold. For instance, the one or more computing devices 502 of the ground system 500 can compare a total number of incidents considered against a total threshold. In an embodiment, the total threshold can be 30. In other embodiments, the total threshold can be any other number. If the total number of incidents is less than the total threshold, then the method 200 can move to (218) and the incidents with parameters below the lower limit or above the upper limit can be replaced with other previous incidents. For instance, the one or more computing devices 502 of the ground system 500 can replace the incidents with parameters below the lower limit or above the upper limit with other previous incidents. After (218), the method 200 can move to (208). If the total number of incidents is equal to or greater than the total threshold, then the method 200 can move to (220) and an error message can be generated. For instance, the one or more computing devices 502 of the ground system 500 can generate an error message. After (220), the method can move to (214).

At (222), a predetermined number of incidents subsequent to the engine wash event can be selected. For instance, the one or more computing devices 502 of the ground system 500 can select a predetermined number of incidents subsequent to the engine wash event. In an embodiment, the incidents can be flights, engine power cycles, and/or the like. In an embodiment, the predetermined number of incidents subsequent to the engine wash event can be 20. In other embodiments, the predetermined number of incidents subsequent to the engine wash event can be any other number. At (224), limits can be determined. For instance, the one or more computing devices 502 of the ground system 500 can determine limits. The determined limits include an upper limit and a lower limit. The determined limits can be determined for one or more parameters related to engine performance. The one or more parameters related to engine performance can include Exhaust Gas Temperature (EGT), EGT Hot Day Margin (EGTHDM), fuel burn, modular efficiency, other analytic measures of engine performance, the like, and/or any combination of the foregoing. A method for determining limits will be described in more detail in FIG. 3 below.

At (226), a determination can be made of if the selected incidents include any incidents with a parameter above the upper limit or a parameter below the lower limit. For instance, the one or more computing devices 502 of the ground system 500 can determine if the selected incidents include any incidents with a parameter above the upper limit or a parameter below the lower limit. If not, then the method 200 can move to (212) and data for all of the selected incidents can be stored (e.g., load, record, etc.) to be used in analysis. For instance, the one or more computing devices 502 of the ground system 500 can store data for all of the selected incidents. After (212), the method 200 can move to (214) and end. For instance, the one or more computing devices 502 of the ground system 500 can end the method 200.

If the selected incidents include any incidents with a parameter above the upper limit or a parameter below the lower limit, the method can move to (228) and a total number of incidents considered can be compared against a total threshold. For instance, the one or more computing devices 502 of the ground system 500 can compare a total number of incidents considered against a total threshold. In an embodiment, the total threshold can be 30. In other embodiments, the total threshold can be any other number. If the total number of incidents is less than the total threshold, then the method 200 can move to (230) and the incidents with parameters below the lower limit or above the upper limit can be replaced with other subsequent incidents. For instance, the one or more computing devices 502 of the ground system 500 can replace the incidents with parameters below the lower limit or above the upper limit with other subsequent incidents. After (230), the method 200 can move to (224). If the total number of incidents is equal to or greater than the total threshold, then the method 200 can move to (232) and an error message can be generated. For instance, the one or more computing devices 502 of the ground system 500 can generate an error message. After (232), the method can move to (214).

FIG. 3 depicts a flow diagram of an example method 300 for determining limits at (208) and/or (224). The method of FIG. 3 can be implemented using, for instance, the one or more computing devices 502 of the ground system 500 of FIG. 5. FIG. 3 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (302), the method 300 can start. For instance, the one or more computing devices 502 of the ground system 500 can start the method 300. The method can be executed (run, etc.) for any of the one or more parameters related to engine performance including Exhaust Gas Temperature (EGT), EGT Hot Day Margin (EGTHDM), fuel burn, modular efficiency, other analytic measures of engine performance, the like, and/or any combination of the foregoing. For example, the method 300 can be run for EGTHDM for one or more incidents. At (304), a first quartile and a third quartile can be determined. For instance, the one or more computing devices 502 of the ground system 500 can determine a first quartile and a third quartile. For example, an EGTHDM first quartile and an EGTHDM third quartile can be determined.

At (306), an interquartile range can be determined. For instance, the one or more computing devices 502 of the ground system 500 can determine an interquartile range. The interquartile range can be determined by subtracting the determined first quartile from the determined third quartile. For example, an EGTHDM first quartile can be subtracted from the EGTHDM third quartile.

At (308), an upper limit can be determined. For instance, the one or more computing devices 502 of the ground system 500 can determine an upper limit. The interquartile range can be multiplied by a factor and added to the third quartile. For example, the factor can be 1.5. In other embodiments, the factor can be any other value. As a further example, the determined interquartile range can be multiplied by the factor and the result can be added to the EGTHDM third quartile to determine the upper limit. Incidents with a parameter having a value above the upper limit can be considered an outlier.

At (310), a lower limit can be determined. For instance, the one or more computing devices 502 of the ground system 500 can determine a lower limit. The interquartile range can be multiplied by a factor and subtracted from the first quartile. For example, the factor can be 1.5. In other embodiments, the factor can be any other value. As a further example, the determined interquartile range can be multiplied by the factor and the result can be subtracted from the EGTHDM first quartile to determine the lower limit. Incidents with a parameter having a value below the lower limit can be considered an outlier. At (312), the method 300 can end. For instance, the one or more computing devices 502 of the ground system 500 can end the method 300.

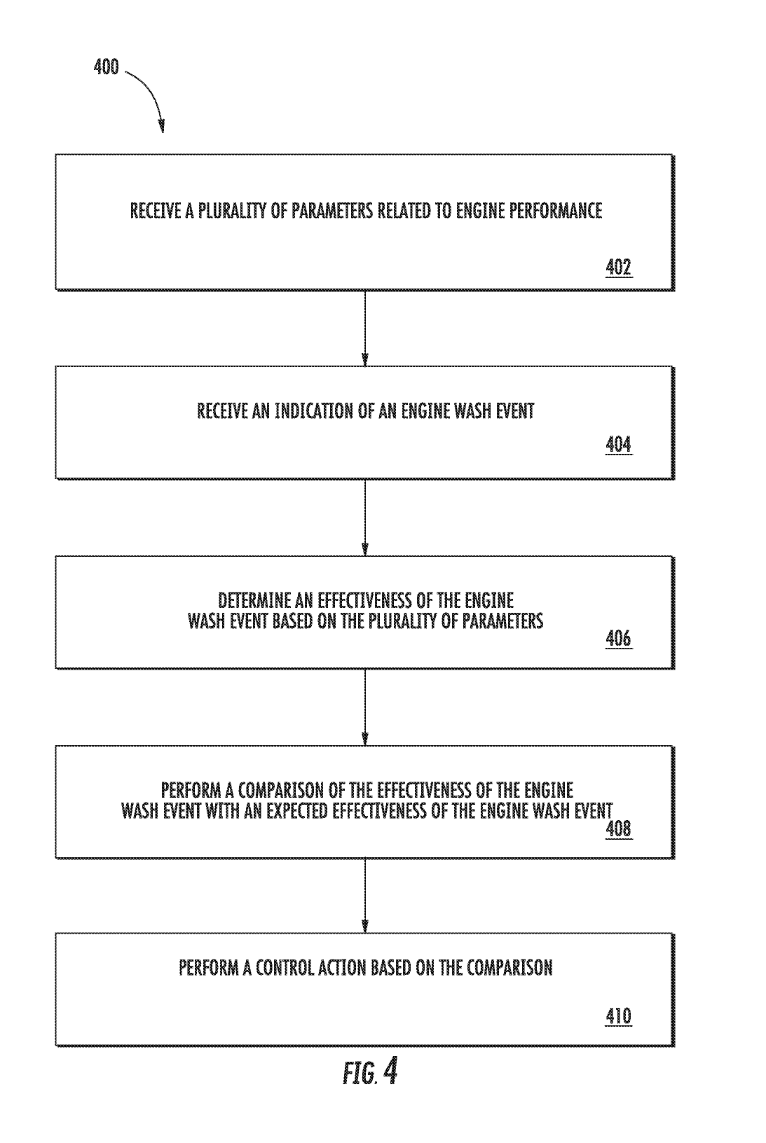

FIG. 4 depicts a flow diagram of an example method 400 for measuring engine performance. The method of FIG. 4 can be implemented using, for instance, the one or more computing devices 502 of the ground system 500 of FIG. 5. FIG. 4 depicts steps performed in a particular order for purposes of illustration and discussion. Those of ordinary skill in the art, using the disclosures provided herein, will understand that various steps of any of the methods disclosed herein can be adapted, rearranged, or modified in various ways without deviating from the scope of the present disclosure.

At (402), a plurality of parameters related to engine performance can be received. For instance, the one or more computing devices 502 of the ground system 500 can receive a plurality of parameters related to engine performance. For example, the plurality of parameters can be received via a wireless communication between a server on the aerial vehicle 100 and the one or more computing devices 502 of the ground system 500. The parameters can include and/or can be used to determine Exhaust Gas Temperature (EGT), EGT Hot Day Margin (EGTHDM), fuel burn, modular efficiency, other analytic measures of engine performance, the like, and/or any combination of the foregoing. Optionally, environmental data can be received. For instance, the one or more computing devices 502 of the ground system 500 can receive environmental data. The environmental data can include, for example, data indicative of a dust storm, an ice storm, etc. The environmental data can be used to determine if an engine may need an engine wash event earlier than a regular schedule would indicate. An engine wash event can be scheduled based on the environmental data. In an embodiment, when engine performance has degraded below a threshold level and no engine wash event has been performed within a threshold window, a time based reminder can be generated and provided to a user. The time based reminder can include a reminder to schedule and/or perform an engine wash event.

At (404), an indication of an engine wash event can be received. For instance, the one or more computing devices 502 of the ground system 500 can receive an indication of an engine wash event. In an embodiment, receiving an indication of an engine wash event can include receiving one or more engine wash event attributes. The one or more engine wash event attributes can include one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, an equipment type, and/or other relevant attributes to a defined wash procedure. In an embodiment, the engine wash event can include a specific value and/or a value within a specific range of values for one or more engine wash event attributes. The specific value and/or the specific range of values can be customizable. The specific value and/or the specific range of values can be based on engine specific information. For example, one type of engine may require that engine wash events include a wash time of at least 30 minutes. In an embodiment, the engine wash event attributes of a plurality of engine wash events can be analyzed and form a basis for a recommendation for one or more engine wash event attributes for a future engine wash event.

At (406), an effectiveness of the engine wash event can be determined based on the plurality of parameters. For instance, the one or more computing devices 502 of the ground system 500 can determine an effectiveness of the engine wash event based on the plurality of parameters. For example, parameters representing data before the engine wash event can be used to determine an engine performance before the engine wash event and parameters representing data after the engine wash event can be used to determine an engine performance after the engine wash event. The engine performance before the engine wash event can be compared with the engine performance after the engine wash event to determine the effectiveness of the engine wash event.

At (408), a comparison of the effectiveness of the engine wash event with an expected effectiveness of the engine wash event can be performed. For instance, the one or more computing devices 502 of the ground system 500 can perform a comparison of the effectiveness of the engine wash event with an expected effectiveness of the engine wash event. In an embodiment, when the effectiveness of the engine wash event does not compare favorably with (for example, is not within a threshold range of) the expected effectiveness, a notification can be created and provided to a user. The expected effectiveness of the engine wash event can be based on manufacturer information, such as a manufacturer recommendation. The expected effectiveness of the engine wash event can be based on wash station information, such as a wash station recommendation. The expected effectiveness of the engine wash event can be based on aggregated engine wash information, one or more models of engine wash effectiveness for an engine, one or more models of engine wash effectiveness for a plane, one or more models of engine wash effectiveness for a fleet, the like, and/or any combination of the foregoing. The expected effectiveness of the engine wash event can be based on one or more attributes of the engine wash event. For example, the one or more models can consider engine wash events with one or more parameters the same or similar to the engine wash event. In an embodiment, determining an effectiveness of the engine wash event can include categorizing the engine wash event into at least one category based, at least in part, on the received one or more engine wash event attributes.

At (410), a control action can be performed based on the comparison. For instance, the one or more computing devices 502 of the ground system 500 can perform a control action based on the comparison. In an embodiment, the control action can include scheduling a new engine wash event based on the comparison. For instance, the one or more computing devices 502 of the ground system 500 can schedule a new engine wash event based on the comparison. In an embodiment, the control action can include scheduling a service based on the comparison. For instance, the one or more computing devices 502 of the ground system 500 can schedule a service based on the comparison. In an embodiment, the control action can include scheduling a maintenance action based on the comparison. For instance, the one or more computing devices 502 of the ground system 500 can schedule a maintenance action based on the comparison.

Optionally, a second plurality of parameters related to engine performance can be received. For instance, the one or more computing devices 502 of the ground system 500 can receive a second plurality of parameters related to engine performance. For example, the second plurality of parameters can be received via a wireless communication between a server on the aerial vehicle 100 and the one or more computing devices 502 of the ground system 500. An indication of a second engine wash event can be received. For instance, the one or more computing devices 502 of the ground system 500 can receive an indication of a second engine wash event. An effectiveness of the second engine wash event can be determined based on the second plurality of parameters. For instance, the one or more computing devices 502 of the ground system 500 can determine an effectiveness of the second engine wash event based on the second plurality of parameters. A second comparison can be performed. For instance, the one or more computing devices 502 of the ground system 500 can perform a second comparison. The second comparison can be a comparison of the effectiveness of the second engine wash event with an expected effectiveness of the second engine wash event. The expected effectiveness of the first engine wash event can be the same as the expected effectiveness of the second engine wash event. The expected effectiveness of the second engine wash event can be influenced by at least the expected effectiveness of the first engine wash event and the effectiveness of the first engine wash event. In an embodiment, an effectiveness of any number of engine wash events can be determined based on any number of plurality of parameters and compared with any number of expected effectiveness of engine wash events.

Optionally, the effectiveness of engine wash events can be modeled based, at least in part, on the effectiveness of the first engine wash event and the effectiveness of the second engine wash event. A model for the effectiveness of engine wash events can be created based, at least in part, on the effectiveness of the first engine wash event. The model can be revised based, at least in part, on the effectiveness of the second engine wash event. A need for a third engine wash event can be predicted based on the model. A user can be notified of the need.

FIG. 5 depicts a block diagram of an example computing system that can be used to implement the ground system 500 or other systems of the aerial vehicle according to example embodiments of the present disclosure. As shown, the ground system 500 can include one or more computing device(s) 502. The one or more computing device(s) 502 can include one or more processor(s) 504 and one or more memory device(s) 506. The one or more processor(s) 504 can include any suitable processing device, such as a microprocessor, microcontroller, integrated circuit, logic device, or other suitable processing device. The one or more memory device(s) 506 can include one or more computer-readable media, including, but not limited to, non-transitory computer-readable media, RAM, ROM, hard drives, flash drives, or other memory devices.

The one or more memory device(s) 506 can store information accessible by the one or more processor(s) 504, including computer-readable instructions 508 that can be executed by the one or more processor(s) 504. The instructions 508 can be any set of instructions that when executed by the one or more processor(s) 504, cause the one or more processor(s) 504 to perform operations. The instructions 508 can be software written in any suitable programming language or can be implemented in hardware. In some embodiments, the instructions 508 can be executed by the one or more processor(s) 504 to cause the one or more processor(s) 504 to perform operations, such as the operations for measuring engine performance, as described with reference to FIGS. 2-4, and/or any other operations or functions of the one or more computing device(s) 502.

The memory device(s) 506 can further store data 510 that can be accessed by the processors 504. For example, the data 510 can include a navigational database, environmental database, data associated with the navigation system(s), data associated with the control mechanisms, data indicative of a flight plan associated with the vehicle 100, data associated with flight director mode selection, data associated with a flight management system, and/or any other data associated with vehicle 100, as described herein. The data 510 can include one or more table(s), function(s), algorithm(s), model(s), equation(s), etc. for measuring engine performance according to example embodiments of the present disclosure.

The one or more computing device(s) 502 can also include a communication interface 512 used to communicate, for example, with the other components of system. The communication interface 512 can include any suitable components for interfacing with one or more network(s), including for example, transmitters, receivers, ports, controllers, antennas, or other suitable components.

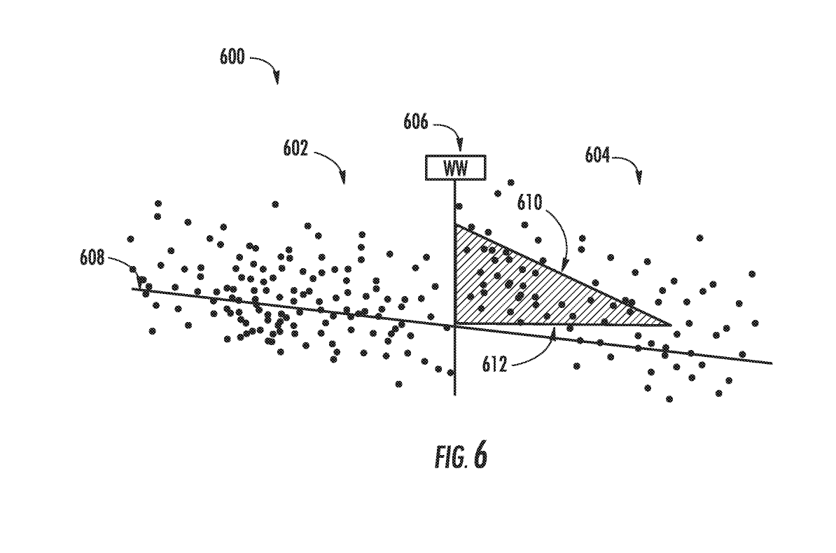

FIG. 6 depicts an example interface 600 according to example embodiments of the present disclosure. For instance, the one or more computing devices 502 of the ground system 500 can output the interface 600. The interface 600 can represent a graph wherein time is represented along a horizontal axis and a parameter for engine performance is represented along a vertical axis. The parameter related to engine performance can include Exhaust Gas Temperature (EGT), EGT Hot Day Margin (EGTHDM), fuel burn, modular efficiency, other analytic measures of engine performance, the like, and/or any combination of the foregoing. The interface 600 can include a first scatterplot 602 and a second scatterplot 604. A vertical line 606 can represent a time when a subject engine wash event occurred. The first scatterplot 602 can reside to the left of the vertical line 606. The second scatterplot 604 can reside to the right of the vertical line 606. A first regression line, average, or other statistical measurement 608 can be created based on the first scatterplot 602. A portion of the first regression line, average, or other statistical measurement 608 extending beyond the vertical line 606 can represent expected engine performance in the absence of the engine wash event. A second regression line, average, or other statistical measurement 610 can be created based on the second scatterplot 604. A difference between the second regression line, average, or other statistical measurement 610 and the first regression line, average, or other statistical measurement 608 can represent an improvement in engine performance attributable to the engine wash event. A horizontal line 612 can be drawn to the right of the intersection of the vertical line 606 and the first regression line, average, or other statistical measurement 608. A triangle can be formed from the vertical line 606, the second regression line, average, or other statistical measurement 610, and the horizontal line 612. In an aspect, the triangle can represent an improvement in engine performance attributable to the engine wash event.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system comprising:
one or more memory devices; and
one or more processors configured to:
receive a plurality of parameters related to engine performance;
receive an indication of an engine wash event;
determine an effectiveness of the engine wash event based on the plurality of parameters;
perform a comparison of the effectiveness of the engine wash event with an expected effectiveness of the engine wash event; and
perform a control action based on the comparison.

2. The system of claim 1, wherein the control action comprises scheduling a new engine wash event based on the comparison.

3. The system of claim 1, wherein the control action comprises scheduling a service based on the comparison.

4. The system of claim 1, wherein the control action comprises scheduling a maintenance action based on the comparison.

5. The system of claim 1, wherein the one or more processors are further configured to:
receive a second plurality of parameters related to engine performance;
receive an indication of a second engine wash event;
determine an effectiveness of the second engine wash event based on the second plurality of parameters; and
perform a second comparison, wherein the second comparison is a comparison of the effectiveness of the second engine wash event with an expected effectiveness of the second engine wash event.

6. The system of claim 5, wherein the expected effectiveness of the first engine wash event is the same as and the expected effectiveness of the second engine wash event.

7. The system of claim 5, wherein the expected effectiveness of the second engine wash event is influenced by at least the expected effectiveness of the first engine wash event and the effectiveness of the first engine wash event.

8. The system of claim 5, wherein the one or more processors are further configured to model the effectiveness of engine wash events based, at least in part, on the effectiveness of the first engine wash event and the effectiveness of the second engine wash event.

9. The system of claim 5, wherein the one or more processors are further configured to create a model of the effectiveness of engine wash events based, at least in part, on the effectiveness of the first engine wash event.

10. The system of claim 9, wherein the one or more processors are further configured to revise the model based, at least in part, on the effectiveness of the second engine wash event.

11. The system of claim 10, wherein the one or more processors are further configured to:
predict a need for a third engine wash event based on the model; and
notify a user of the need.

12. The system of claim 1, wherein receiving an indication of an engine wash event further comprises receiving one or more engine wash event attributes.

13. The system of claim 12, wherein determining an effectiveness of the engine wash event further comprises categorizing the engine wash event into at least one category based, at least in part, on the received one or more engine wash event attributes.

14. The system of claim 12, wherein the one or more engine wash event attributes comprises one or more of the following: a wash date, a wash time, a wash station, a washer, a washer skill level, a worker experience level, a worker training level, a number of washers, an engine, a fleet, a number of wash cycles, a total dissolved solvents measurement at each cycle, a total suspended solvents measurement at each cycle, a number of rinses, a total dissolved solids, or an equipment type.

15. A method for measuring engine performance comprising:
receiving, by one or more computing devices, a plurality of parameters related to engine performance;
receiving, by the one or more computing devices, an indication of an engine wash event;
determining, by the one or more computing devices, an effectiveness of the engine wash event based on the plurality of parameters;
performing, by the one or more computing devices, a comparison of the effectiveness of the engine wash event with an expected effectiveness of the engine wash event; and
performing, by the one or more computing devices, a control action based on the comparison.

16. The method of claim 15, wherein the control action comprises scheduling, by the one or more computing devices, a new engine wash event based on the comparison.

17. The method of claim 15, wherein the control action comprises scheduling, by the one or more computing devices, a service based on the comparison.

18. The method of claim 15, wherein the control action comprises scheduling, by the one or more computing devices, a maintenance action based on the comparison.

19. The method of claim 15, further comprising:
receiving, by the one or more computing devices, a second plurality of parameters related to engine performance;
receiving, by the one or more computing devices, an indication of a second engine wash event;
determining, by the one or more computing devices, an effectiveness of the second engine wash event based on the second plurality of parameters; and
performing, by the one or more computing devices, a second comparison, wherein the second comparison is a comparison of the effectiveness of the second engine wash event with an expected effectiveness of the second engine wash event.

20. An aerial vehicle comprising:
one or more memory devices; and
one or more processors configured to:
receive a plurality of parameters related to engine performance;
receive an indication of an engine wash event;
determine an effectiveness of the engine wash event based on the plurality of parameters;
perform a comparison of the effectiveness of the engine wash event with an expected effectiveness of the engine wash event; and
perform a control action based on the comparison.
